(19) United States
(12) Patent Application Publication
(10) Pub. No.: US 2025/0091227 A1
(43) Pub. Date: Mar. 20, 2025

(54) Mobile Robot, Method and Control System

(71) Applicant: ABB Schweiz AG, Baden (CH)

(72) Inventor: Jonatan Blom, Enskede (SE)

(21) Appl. No.: 18/832,728

(22) PCT Filed: Jan. 31, 2022
(86) PCT No.: PCT/EP2022/052198

§ 371 Date: Jul. 24, 2024

(51) Int. Cl. B25J 15/00; B25J 5/00

(52) U.S. Cl. CPC B25J 15/0019; B25J 5/007

(57) ABSTRACT

A mobile robot having a body; a winding member carried by the body; a traction arrangement configured to move the body over a surface with a translational motion along a path; and an elongated line wound around the winding member, wherein the mobile robot is capable of performing a rotational motion of the winding member relative to the surface independently of the translational motion the body. A method and a control system for controlling a mobile robot are also provided.

### TECHNICAL FIELD

The present disclosure generally relates to a mobile robot. In particular, a mobile robot comprising a winding member and an elongated line, a method of controlling a mobile robot, and a control system for controlling a mobile robot, are provided.

### BACKGROUND

In some mobile robot applications, it is desired to connect the mobile robot with a line to a stationary device. One example of such application is when a mobile robot performs a cleaning operation and is supplied with water and/or air with high flows through a line from a stationary source. A further example of such application is when a mobile robot performs a painting operation and is supplied with paint and air through a line from a stationary source. A still further example of such application is when the mobile robot performs a high-power operation, such as welding, grinding or polishing, and the mobile robot is supplied with electric power from a stationary mains supply, e.g. when it is not suitable to provide the power from a battery on the mobile robot.

CN 104786236 A discloses an omnidirectional mobile platform used as a chassis for an industrial robot and a control cabinet. The platform is provided with a retractable cable reel on which a power supply cable is wound. The cable reel has a built-in coil spring. The power supply cable powers the industrial robot and the control cabinet.

Since the cable reel in CN 104786236 A is biased to rotate by the coil spring, tension will always be induced in the power supply cable. It is therefore not possible to lay the power supply cable on the ground in a slack state along a curved path. Furthermore, a capacity of a coil spring is limited to a relatively small number of turns, which strongly limits the operation range of the platform.

### SUMMARY

One object of the invention is to provide an improved mobile robot.

A further object of the invention is to provide an improved method of controlling a mobile robot.

A still further object of the invention is to provide an improved control system for controlling a mobile robot.

These objects are achieved by the mobile robot, the method and the control system according to the respective independent claims.

The invention is based on the realization that by providing a mobile robot having a winding member and a line wound around the winding member, where the mobile robot is capable of performing a rotational motion of the winding member relative to a surface independently of a translational motion of a body over the surface, the line can be laid out in a slack state along a curved path.

The invention is furthermore based on the realization that by configuring the rotational motion of the winding member to be realized, at least partially, by a traction arrangement, the winding capacity is not dependent on relative rotation between the winding member and the body. That is, even a winding member being immobile in relation to the body is functional according to the present invention.

According to a first aspect, there is provided a mobile robot comprising a body; a winding member carried by the body; a traction arrangement configured to move the body over a surface with a translational motion along a path; and an elongated line wound around the winding member; wherein the mobile robot is capable of performing a rotational motion of the winding member relative to the surface independently of the translational motion of the body.

The ability of the mobile robot to control the rotational motion of the winding member independently of the translational motion of the body enables the line to be laid out in a slack state along an arbitrary path, for example along a path comprising a curved shape on the surface on which the mobile robot travels. When the line is not tensioned on the surface, the line is kept still and does not risk to interfere with ambient obstacles. This enables the mobile robot to navigate through a complex environment to a target location where the mobile robot can perform a desired task. Moreover, the mobile robot can travel more stably when there is no tension in the line. Thus, the performance of the mobile robot is improved.

Since the mobile robot is capable of performing a rotational motion of the winding member independently of a translational motion of the body, the mobile robot can perform a translational motion of the body over the surface without a rotational motion the winding member relative to the surface, or perform a rotational motion of the winding member relative to the surface without performing a translational motion of the body over the surface.

Although the mobile robot is capable of performing the rotational motion of the winding member independently of the translational motion of the body, the translational motion of the body may be considered in the control of the rotational motion. For example, when a translational speed of the body is relatively high, the rotational speed of the winding member may be relatively high, and vice versa. The rotational speed of the winding member may also vary for a constant translational speed of the body, e.g. as a distance from a stationary device to the mobile robot increases while the line is wound out from the winding member due to a decreasing effective winding radius of the line around the winding member.

The line may comprise, or be constituted by, an electric cable, a hose or other type of line. The line may be flexible. With flexible line is meant that the line can be wound around the winding member.

The mobile robot can perform the rotational motion of the winding member and the translational motion of the body to wind out the line from the winding member when the line is wound around the winding member. Conversely, the mobile robot can perform the rotational motion of the winding member and the translational motion of the body to wind in the line around the winding member when the line is unwound from the winding member. In any case, the rotational motion of the winding member and the translational motion of the body may be performed simultaneously or alternatingly.

The body may be a platform or other base structure. The body may be positioned between the traction arrangement and the winding member.

The winding member may be of various different shapes. The winding member may for example be cylindrical.

The traction arrangement may comprise a plurality of wheels. At least one of the wheels may be a traction wheel. Alternatively, the traction arrangement may comprise two continuous tracks. In any case, the translational motion may be one dimensional or two dimensional.

The mobile robot may comprise a manipulator. The manipulator may be programmable in two or more axes, such as in six or seven axes. The manipulator may comprise a manipulator base fixed to the winding member and/or to the body. Alternatively, the manipulator base may constitute the winding member.

The mobile robot may comprise at least one motor configured to directly or indirectly control the rotational motion of the winding member. The at least one motor may be one or more motors of the traction arrangement and/or a dedicated winding member motor for rotating the winding member. The mobile robot may be an automated guided vehicle, AGV.

In one variant, the mobile robot comprises two lines and two winding members. In this case, each line may be arranged to be wound in on, and wound out from, a respective winding member. The two winding members may or may not rotate in common.

The mobile robot may further comprise a consumer carried by the body and arranged to rotate in common with the winding member. In this case, the line may be connected to the consumer.

The rotation of the consumer in common with the winding member is of great advantage. In case the line is an electric cable, a slip ring between the line and the consumer can be avoided. In case the line is a hose or other fluid line, a rotating seal for fluid connection between the line and the consumer can be avoided. The mobile robot is therefore made more cost efficient and less error-prone. Examples of electric cables comprise power cables and signal cables. Examples of hoses comprise paint hoses, cleaning medium hoses, water hoses, air hoses and hydraulic fluid hoses.

The consumer may be a fluid consumer or an electric consumer. The line may thus be electrically connected and/or fluidically connected to the consumer. The line may be directly connected to the consumer, e.g. such that there are no intermediate components between the line and the consumer. The consumer may be configured to consume fluid or electric power to thereby perform a work function. Specific examples of consumers comprise a manipulator, an electric control system and a tool, such as a paint gun, a welding gun or a nozzle. The consumer may be positioned externally of the body and/or may be integrated in the body. In case the line is connected to a manipulator of the mobile robot, the manipulator constitutes a consumer that rotates in common with the winding member.

In one variant, the mobile robot comprises two lines, two winding members and two consumers. In this case, each line may be arranged to be wound in on, and wound out from, a respective winding member. The two winding members may or may not rotate in common. A first consumer may be arranged to rotate in common with a first winding member and a second consumer may be arranged to rotate in common with a second winding member.

The mobile robot may be configured to perform an omnidirectional motion of the winding member relative to the surface. The omnidirectional motion enables the winding member to be moved with three degrees of freedom, namely with an arbitrary translational motion along the surface (first and second degrees of freedom) at the same time as the winding member rotates in an arbitrary direction (third degree of freedom). The omnidirectional motion enables the line to be more efficiently laid out in complex environments.

According to one variant, the traction arrangement is configured to perform an omnidirectional motion of the body. This enables the winding member to be fixed to the body (which can then also perform the omnidirectional motion). The traction arrangement can then be used to perform a desired translational motion of the body in any direction along a surface while at the same time generating a desired rotational motion of the winding member.

According to a further variant, the traction arrangement comprises a differential drive, e.g. two parallel traction wheels or two parallel traction tracks in combination with a winding member rotatable relative to the body about a vertical axis. In this case, the differential drive provides two degrees of freedom and the rotation of the winding member relative to the body provides a third degree of freedom. Also in this way, an omnidirectional motion of the winding member can be obtained.

Alternatively, or in addition, the mobile robot may be configured to perform the rotational motion, at least partially, by the traction arrangement. Also in this way, it is enabled that the winding member can remain fixed to the body. In this variant, the winding member may or may not perform an omnidirectional motion relative to the surface.

The line may comprise a first end and a second end. The first end may be configured to be connected to a stationary device. The stationary device is stationary with respect to the surface, such as fixed thereon. The second end may be connected to the consumer or to the winding member. The second end may be fixedly connected to the consumer, i.e. without any slip rings or rotatable couplings. In this regard, a plug connected to a socket is considered to be fixedly connected to the socket if there is no relative movement between the plug and the socket. The line may be integral all the way from the first end to the second end.

The rotational motion of the winding member may comprise a rotation about a rotation axis angled 45° to 135°, such as 70° to 110°, to the surface. In case the rotation axis is a vertical axis angled 90° to the surface, the winding and unwinding of the line can be performed efficiently.

The mobile robot may further comprise a guide for controlling a position of the line. The guide may comprise one or more motors for controlling movements of the guide. Examples of such motors comprise a rotating motor and a vertical motor as described herein. The one or more motors may be electric motors. It is however also possible to realize the guide purely mechanically, for example such that a movement of the winding member relative to the body is transmitted to a movement of the guide to control the position of the line.

The guide may be configured to control a winding position of the line relative to the winding member when the line is wound in on the winding member. To this end, the guide may be configured to move vertically relative to the winding member. The winding position may be controlled based on a size of the winding member (such as an external diameter thereof) and a thickness of the line.

The guide may be configured to control a lay down position of the line relative to the body when the line is wound out from the winding member. To this end, the guide may be configured to rotate relative to the winding member in a rotation direction opposite to a rotation direction of the winding member. In this way, the guide can always face a trailing end of the mobile robot. The line may or may not be laid down on the surface on which the mobile robot travels.

According to a second aspect, there is provided a method of controlling a mobile robot, the method comprising providing a mobile robot comprising a body, a winding member carried by the body, a traction arrangement configured to move the body over a surface with a translational motion along a path, and an elongated line wound around the winding member, the mobile robot being capable of performing a rotational motion of the winding member relative to the surface independently of the translational motion of the body; and controlling the mobile robot to perform the rotational motion of the winding member and the translational motion of the body to wind out the line from the winding member. The mobile robot of the second aspect may be of any type of the first aspect, and vice versa.

The rotational motion of the winding member may be performed, at least partially, by the traction arrangement.

The method may further comprise laying the line along a non-straight path by the translational motion of the body and the rotational motion of the winding member, and storing position information associated with one or more positions of the path. In this case, the method may further comprise controlling the mobile robot based on the position information to perform the translational motion of the body and the rotational motion of the winding member to wind in the line around the winding member. This enables the mobile robot to remember how the line has been laid out in an environment. As a consequence, the line can be laid in complex shapes and navigation through complex environments is improved.

According to a third aspect, there is provided a control system for controlling a mobile robot, the mobile robot comprising a body; a winding member carried by the body; a traction arrangement configured to move the body over a surface with a translational motion along a path; and an elongated line wound around the winding member; where the mobile robot is capable of performing a rotational motion of the winding member relative to the surface independently of the translational motion of the body; the control system comprising at least one data processing device and at least one memory having at least one computer program stored thereon, the at least one computer program comprising program code which, when executed by the at least one data processing device, causes the at least one data processing device to control the mobile robot to perform a rotational motion of the winding member relative to the surface and the translational motion of the body to wind out the line from the winding member.

The at least one computer program may comprise program code which, when executed by the at least one data processing device, causes the at least one data processing device to perform, or command performance of, any step described herein. The control system may be configured to control a mobile robot of any type mentioned in connection with the first and second aspects.

### BRIEF DESCRIPTION OF THE DRAWINGS

Further details, advantages and aspects of the present disclosure will become apparent from the following description taken in conjunction with the drawings, wherein:

FIG. 1a: schematically represents a side view of a mobile robot;

FIG. 1b: schematically represents a top view of the mobile robot;

FIG. 2: schematically represents a partial perspective view of the mobile robot;

FIG. 3: schematically represents a block diagram of components of the mobile robot;

FIG. 4a: schematically represents a top view of the mobile robot when travelling along a path;

FIG. 4b: schematically represents a top view of the mobile robot after further travel along the path;

FIG. 4c: schematically represents a top view of the mobile robot after further travel along the path when the mobile robot has reached a target location;

FIG. 5: schematically represents a side view of a further example of a mobile robot;

FIG. 6: schematically represents a side view of a further example of a mobile robot;

FIG. 7: schematically represents a block diagram of components of the mobile robot in FIG. 6;

FIG. 8: schematically represents a top view of a further example of a mobile robot; and

FIG. 9: schematically represents a top view of a further example of a mobile robot.

### DETAILED DESCRIPTION

In the following, a mobile robot comprising a winding member and an elongated line, a method of controlling a mobile robot, and a control system for controlling a mobile robot, will be described. The same or similar reference numerals will be used to denote the same or similar structural features.

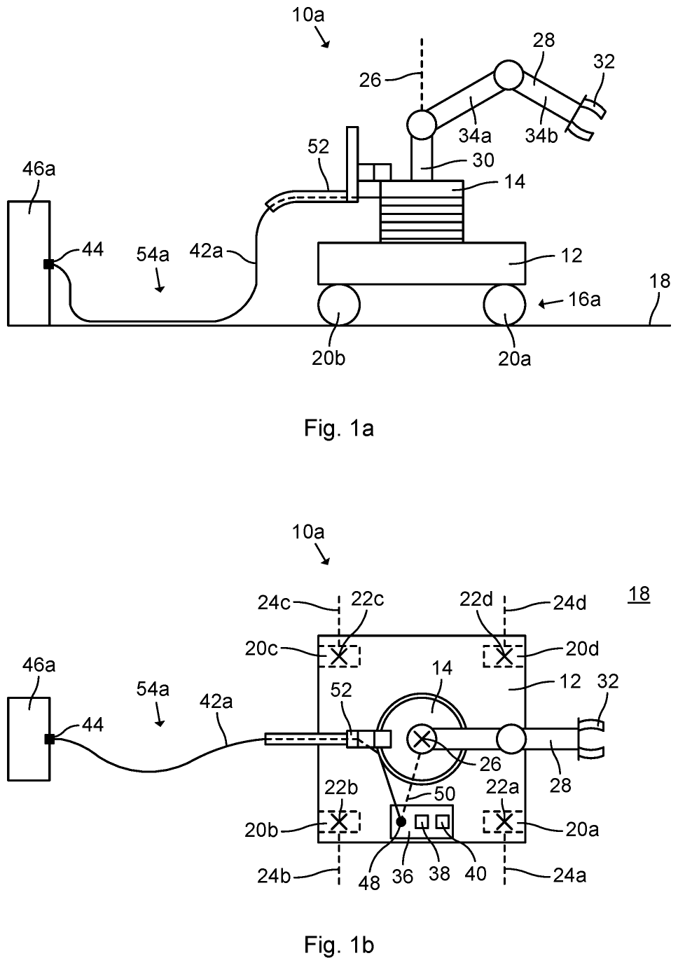

FIG. 1a schematically represents a side view of a mobile robot 10a, and FIG. 1b schematically represents a top view of the mobile robot 10a. With collective reference to FIGS. 1a and 1b, the mobile robot 10a comprises a body 12, a winding member 14 and a traction arrangement 16a. The mobile robot 10a is positioned on a surface 18, here exemplified as a horizontal floor. The mobile robot 10a of this example is an automated guided vehicle, AGV.

The body 12 is here exemplified as a platform parallel with the surface 18. In this example, the winding member 14 is fixed on top of the body 12. The winding member 14 of this example is a cylinder.

The traction arrangement 16a is configured to move the body 12 over the surface 18. The traction arrangement 16a of this example comprises a plurality of wheels 20a-20d, here four traction wheels 20a-20d. The first wheel 20a is rotatable about a vertical first steering axis 22a and about a horizontal first wheel axis 24a, intersecting the first steering axis 22a. The second wheel 20b is rotatable about a vertical second steering axis 22b and about a horizontal second wheel axis 24b, intersecting the second steering axis 22b. The third wheel 20c is rotatable about a vertical third steering axis 22c and about a horizontal third wheel axis 24c, intersecting the third steering axis 22c. The fourth wheel 20d is rotatable about a vertical fourth steering axis 22d and about a horizontal fourth wheel axis 24d, intersecting the fourth steering axis 22d. Due to the traction arrangement 16a, the mobile robot 10a is configured to perform an omnidirectional motion of the body 12. The winding member 14 is centered between the steering axes 22a-22d. Also the winding member 14 can thereby perform an omnidirectional motion. The mobile robot 10a can for example rotate the body 12 on the spot to rotate the winding member 14 about a rotation axis, here exemplified as a vertical axis 26.

The mobile robot 10a of this example further comprises a manipulator 28. The manipulator 28 of this example comprises a manipulator base 30, an end effector 32 and a plurality of links 34a and 34b, here a first link 34a and a second link 34b. The manipulator base 30 is here fixed to the winding member 14 and aligned with the vertical axis 26.

The mobile robot 10a further comprises an electric control system 36. The control system 36 is carried by the body 12. The control system 36 of this example comprises a data processing device 38 and a memory 40 having a computer program stored thereon. The computer program comprises program code which, when executed by the data processing device 38, causes the data processing device 38 to perform, or command performance of, various steps as described herein.

The mobile robot 10a further comprises an elongated line 42a, here exemplified as a flexible electric power cable. The line 42a comprises a first end 44 connected to a stationary device 46a and a second end 48 connected to the control system 36. The line 42a electrically powers the control system 36. The line 42a is integral from the first end 44 to the second end 48. The stationary device 46a of this example is a mains supply. The line 42a is directly connected to each of the stationary device 46a and the control system 36 without using slip rings. The line 42a may thus be said to be fixedly connected to the stationary device 46a and the control system 36. As shown, the line 42a is wound around the winding member 14.

Since the line 42a is connected to the control system 36, the control system 36 is one example of a consumer. In this example, the control system 36 is electrically connected to the manipulator base 30 via a manipulator cable 50. The manipulator 28 can thereby perform high-power operations without needing to carry a battery.

The mobile robot 10a of this example further comprises a guide 52. The guide 52 is configured to control a position of the line 42a relative to the winding member 14 and relative to the body 12.

Due to the omnidirectional motion of the traction arrangement 16a, the mobile robot 10a can control rotation of the winding member 14 about the vertical axis 26 independently of a translational motion of the body 12. For example, the winding member 14 can rotate about the vertical axis 26 when the body 12 travels along a straight path. As a further example, the winding member 14 can be controlled to not rotate in space while the body 12 travels along a curved path on the surface 18.

The mobile robot 10a is configured to lay down the line 42a on, or substantially on, a path 54a along which the mobile robot 10a travels. To this end, the winding member 14 is rotated such that the line 42a is unwound from the winding member 14 when the mobile robot 10a travels along the path 54a. Since the winding member 14 can be rotated about the vertical axis 26 independently of the translational motion of the body 12, the line 42a can be laid on the surface 18 without being tensioned, in contrast to if using a spring-biased cable reel.

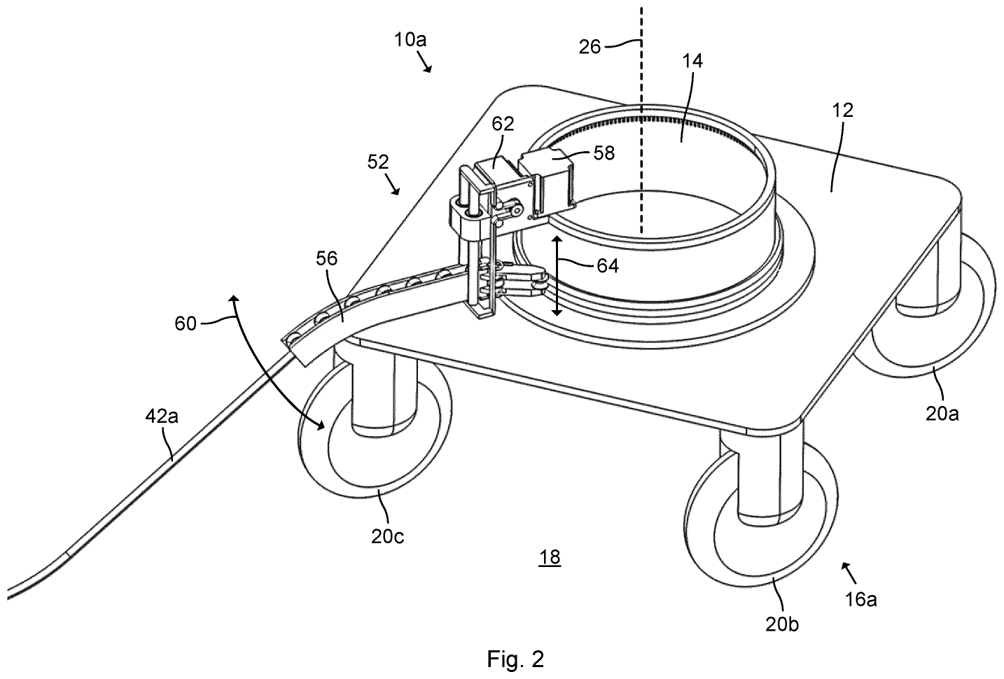

FIG. 2 schematically represents a partial perspective view of the mobile robot 10a. In the view in FIG. 2, the control system 36 and the manipulator 28 are omitted. FIG. 2 shows one of many specific examples of the guide 52. The guide 52 of this example comprises a holding part 56. The holding part 56 holds the line 42a and extends horizontally outside the body 12.

The guide 52 of this example further comprises an electric rotating motor 58 arranged to drive the holding part 56 to rotate relative to the winding member 14 about the vertical axis 26, as shown with arrow 60 lying in a horizontal plane. In this way, a lay down position of the line 42a relative to the body 12 can be controlled when the line 42a is wound out from the winding member 14.

The guide 52 of this example further comprises an electric vertical motor 62 arranged to drive the holding part 56 to move vertically relative to the winding member 14, as shown with arrow 64. In this way, a vertical winding position of the line 42a relative to the winding member 14 can be controlled when the line 42a is wound in on the winding member 14.

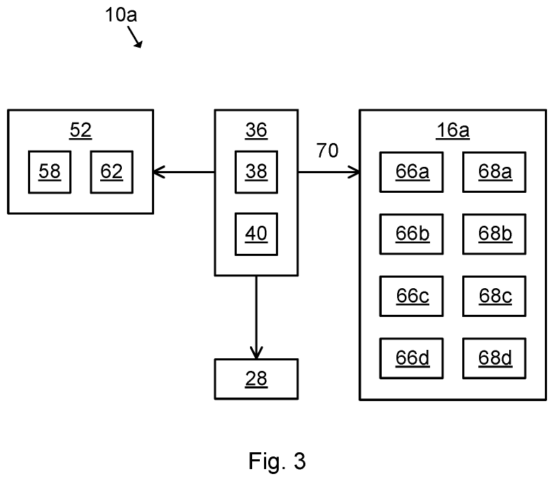

FIG. 3 schematically represents a block diagram of components of the mobile robot 10a. As shown in FIG. 3, the control system 36 electrically powers and controls the guide 52. Moreover, FIG. 3 shows that the control system 36 electrically powers and controls the traction arrangement 16a. As schematically shown in FIG. 3, the traction arrangement 16a comprises first to fourth steering motors 66a-66d for driving the first to fourth wheels 20a-20d about the respective steering axes 22a-22d, and first to fourth wheel motors 68a-68d for driving the first to fourth wheels 20a-20d about the respective wheel axes 24a-24d.

The control system 36 is configured to send control signals 70 to the traction arrangement 16a to cause the traction arrangement 16a to perform a translational motion of the body 12 and/or a rotational motion of the winding member 14. The control system 36 is configured to store the control signals 70 as sent to the traction arrangement 16a. In this way, the control system 36 can keep track of the path 54a travelled by the mobile robot 10a. The control signals 70 thus constitute one example of position information according to the present disclosure.

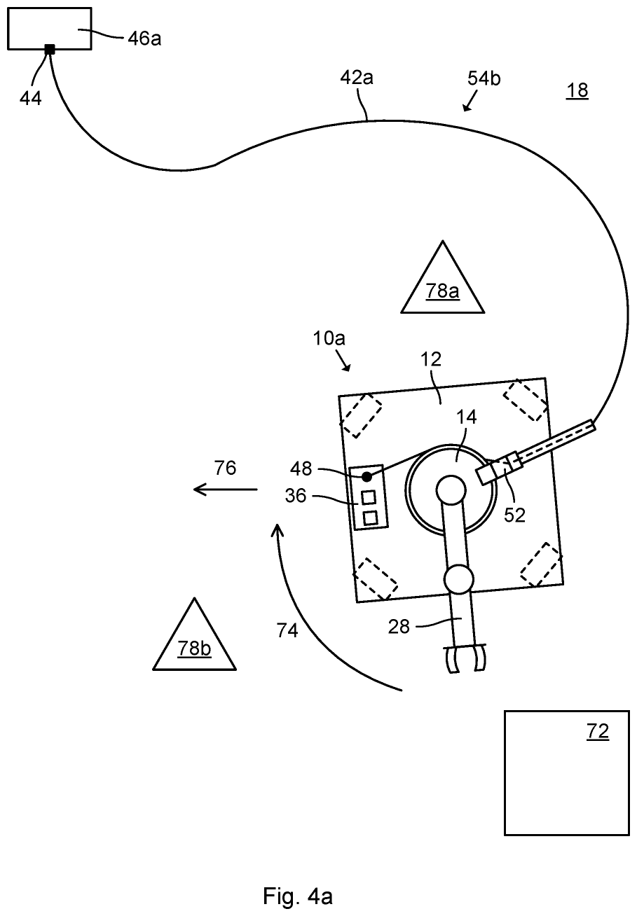

FIG. 4a schematically represents a top view of the mobile robot 10a when travelling towards a target location 72. The mobile robot 10a travels along a non-straight path 54b comprising multiple curves of different types. The path 54a may form an initial part of the path 54b. The position information indicative of the path 54b is stored in the control system 36 during travel to the target location 72.

In this example, the mobile robot 10a performs both a rotational motion 74 of the winding member 14 to unwind the line 42a therefrom, and a simultaneous translational motion 76 of the body 12 to travel to the target location 72 along the path 54b. In this example, the body 12, the winding member 14, the control system 36 and the manipulator base 30 remain in a fixed relationship and rotate in common. There is thus no relative rotation between the winding member 14 and the control system 36. This enables slip rings between the line 42a and the control system 36 to be avoided. Moreover, the fixed relationship between the control system 36 and the manipulator base 30 enables the manipulator cable 50 to interconnect the control system 36 and the manipulator base 30 without using any slip rings.

The guide 52 always guides the line 42a to be reeled off the winding member 14 at a trailing end (which varies) of the mobile robot 10a. Since the line 42a is held and guided by the guide 52 in this way, it is avoided that the line 42a is stuck under the mobile robot 10a. In FIG. 4a, the winding member 14 rotates in a clockwise direction in relation to the surface 18 and the guide 52 rotates in a counterclockwise direction in relation to the winding member 14.

In FIG. 4a, the mobile robot 10a has rounded a first obstacle 78a. Since the rotational motion 74 can be performed independently of the translational motion 76, the line 42a does not have to be tensioned to be reeled off the winding member 14. The line 42a can thus be laid on the surface 18 without tension. The line 42a stays in place on the surface 18 as the travelling progresses without risking interference between the line 42a and the first obstacle 78a.

FIG. 4b schematically represents a top view of the mobile robot 10a after further travel along the path 54b. In FIG. 4b, the mobile robot 10a has rounded a second obstacle 78b. The guide 52 is still at a trailing end of the mobile robot 10a. However, the relationship between the guide 52 and the manipulator 28 is different in FIGS. 4a and 4b.

FIG. 4c schematically represents a top view of the mobile robot 10a after further travel along the path 54b when the mobile robot 10a has reached a target location 72. The manipulator 28 can now perform a high-power operation at the target location 72 while being electrically powered from the stationary device 46a via the line 42a.

In order to return the mobile robot 10a to the stationary device 46a, the above procedure is reversed. Since the position information indicative of the path 54b has been stored during travel to the target location 72, the mobile robot 10b knows the shape of the path 54b and can efficiently pick up the line 42a by controlling the translational motion 76 along the path 54b and by rotating the winding member 14 (now counterclockwise in FIG. 4c) to wind in the line 42a on the winding member 14.

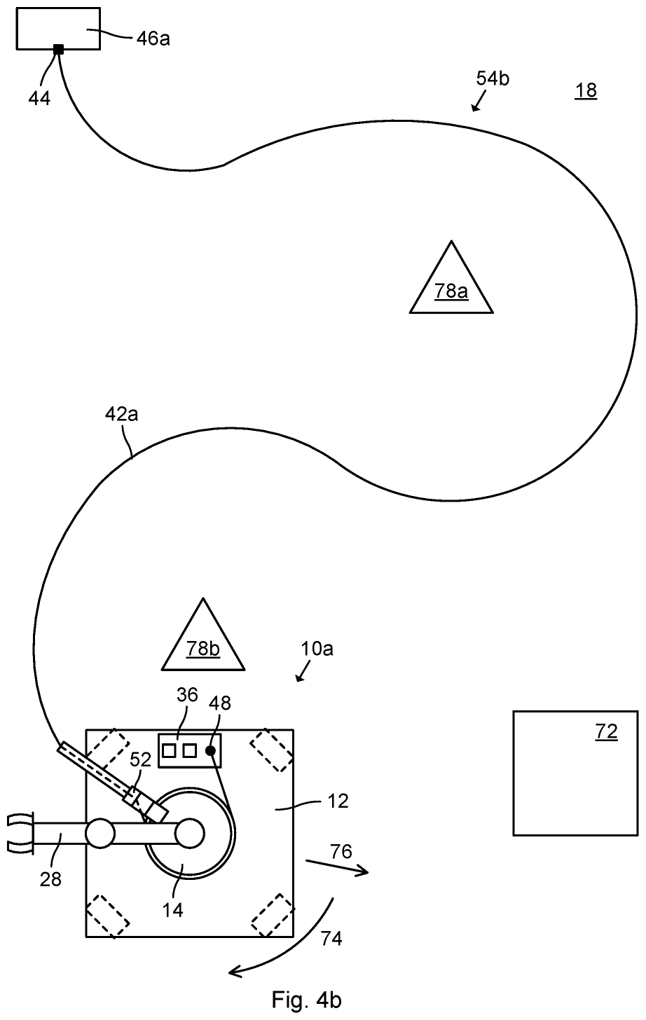

FIG. 5 schematically represents a side view of a further example of a mobile robot 10b. The mobile robot 10b differs from the mobile robot 10a by comprising a traction arrangement 16b. The traction arrangement 16b comprises a plurality of (here four) Swedish wheels or Mecanum wheels 80. By means of the Mecanum wheels 80, the mobile robot 10b can perform an omnidirectional motion of the body 12 and the winding member 14 fixed thereon.

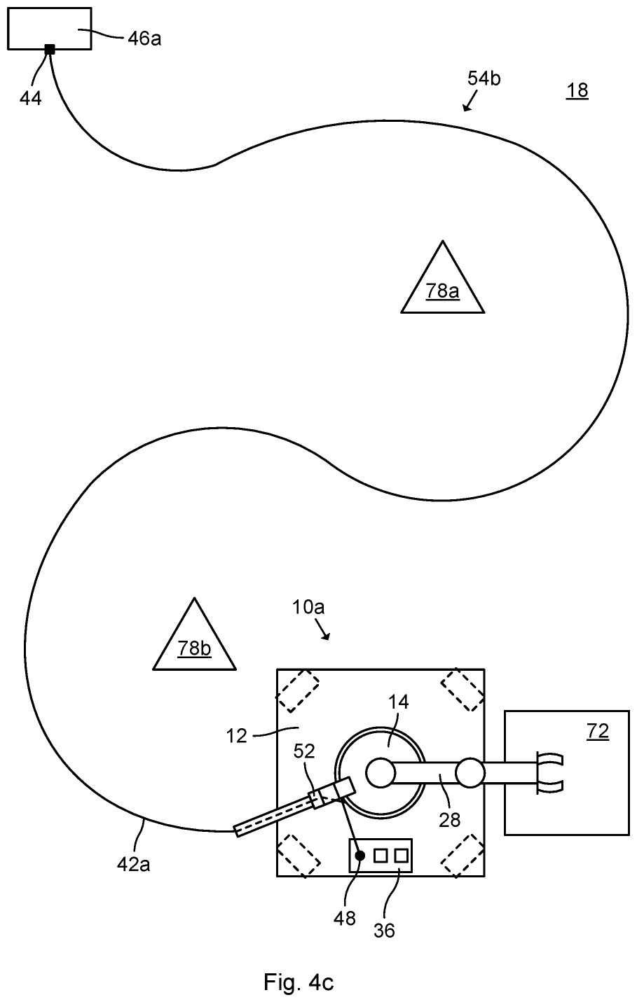

FIG. 6 schematically represents a side view of a further example of a mobile robot 10c. Mainly differences with respect to the mobile robot 10a will be described. In the mobile robot 10c, the winding member 14 is arranged to rotate relative to the body 12 about the vertical axis 26 with rotational motion 74.

The mobile robot 10c comprises a traction arrangement 16c. The traction arrangement 16c comprises two parallel fixed direction wheels 82 (only one is visible in FIG. 6) forming a differential drive. The fixed direction wheels 82 are arranged to rotate about a wheel axis perpendicular to, and intersecting with, the vertical axis 26. The traction arrangement 16c further comprises an optional caster wheel 84. The fixed direction wheels 82 provide two degrees of freedom and the rotation of the winding member 14 relative to the body 12 provides a third degree of freedom. Thereby, also the winding member 14 of the mobile robot 10c can perform an omnidirectional motion.

The mobile robot 10c of this specific example further comprises a spray nozzle 86 for spraying cleaning medium 88 to clean an environment, e.g. at the target location 72. The spray nozzle 86 is here fixed to the winding member 14. The spray nozzle 86 may however alternatively be carried by a manipulator 28.

The mobile robot 10c of this example further comprises a line 42b. The line 42b is a cleaning medium hose for supplying the cleaning medium 88 to the spray nozzle 86. The line 42b comprises a first end 44 connected to a stationary device 46b, here exemplified as a cleaning medium supply. The line 42b is guided by the guide 52 and is wound around the winding member 14. As shown in FIG. 6, a second end 48 of the line 42b is directly connected to the spray nozzle 86. The spray nozzle 86 is thus a further example of a consumer. Since the winding member 14 and the spray nozzle 86 rotate in common, no rotating seals are needed between the line 42b and the spray nozzle 86. The mobile robot 10c may be electrically powered by an energy storage, such as a battery.

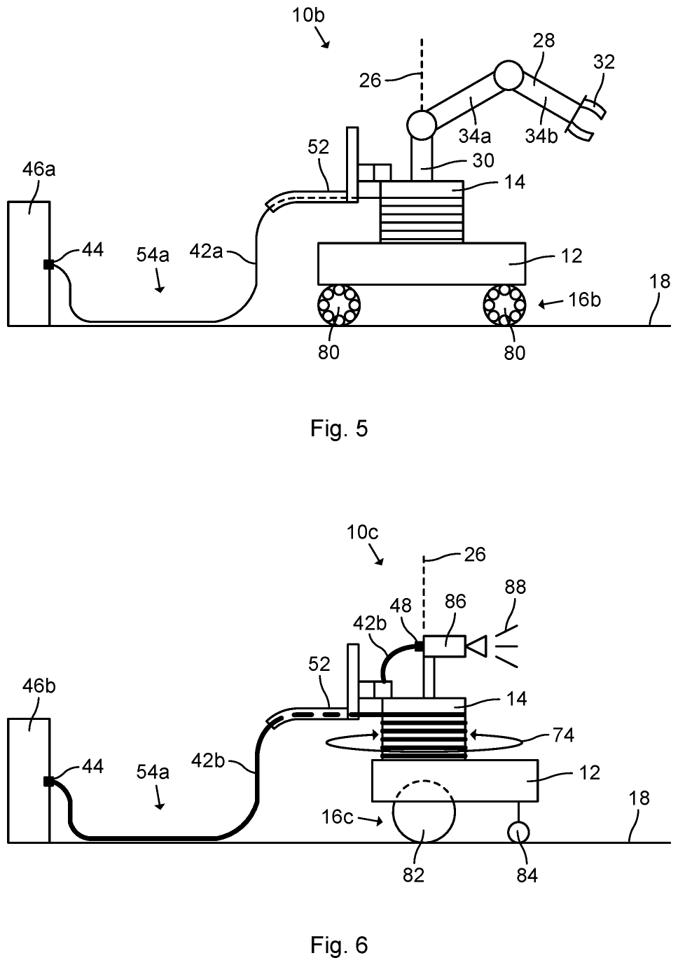

FIG. 7 schematically represents a block diagram of components of the mobile robot 10c. Mainly differences from FIG. 3 will be described. As shown in FIG. 7, the traction arrangement 16c comprises two wheel motors 68e and 68f for driving the fixed direction wheels 82. The mobile robot 10c further comprises a winding member motor 90 for controlling rotation of the winding member 14 relative to the body 12.

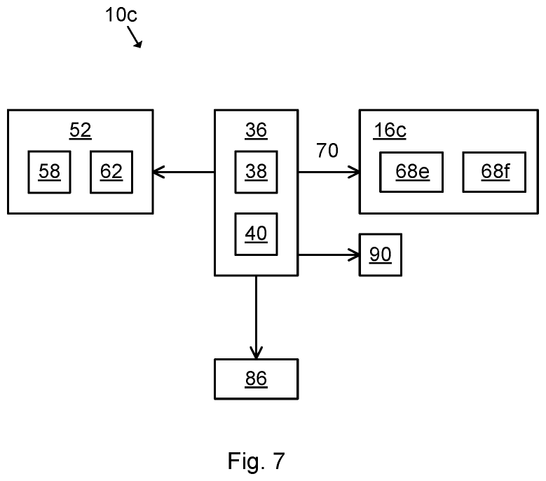

FIG. 8 schematically represents a top view of a further example of a mobile robot 10d. The mobile robot 10d comprises a traction arrangement 16d. The traction arrangement 16d differs from the traction arrangement 16a in that two wheels 20b and 20c are fixed direction wheels. Similarly to the mobile robot 10c, the winding member 14 of the mobile robot 10d is rotatable relative to the body 12 in the mobile robot 10d. The mobile robot 10d is not capable of performing an omnidirectional motion of the winding member 14. However, the traction arrangement 16d can perform a two-dimensional translational motion 76 and the winding member 14 can perform a rotational motion 74 independently of the translational motion 76.

Moreover, as shown in FIG. 8, the second end 48 of the line 42a is directly connected to the manipulator base 30. The manipulator 28 is electrically powered via the line 42a. The manipulator 28 is thus a further example of a consumer. The control system 36 of the mobile robot 10d comprises an energy storage 92, here exemplified as a battery. The energy storage 92 electrically powers the control system 36, the traction arrangement 16d and the guide 52.

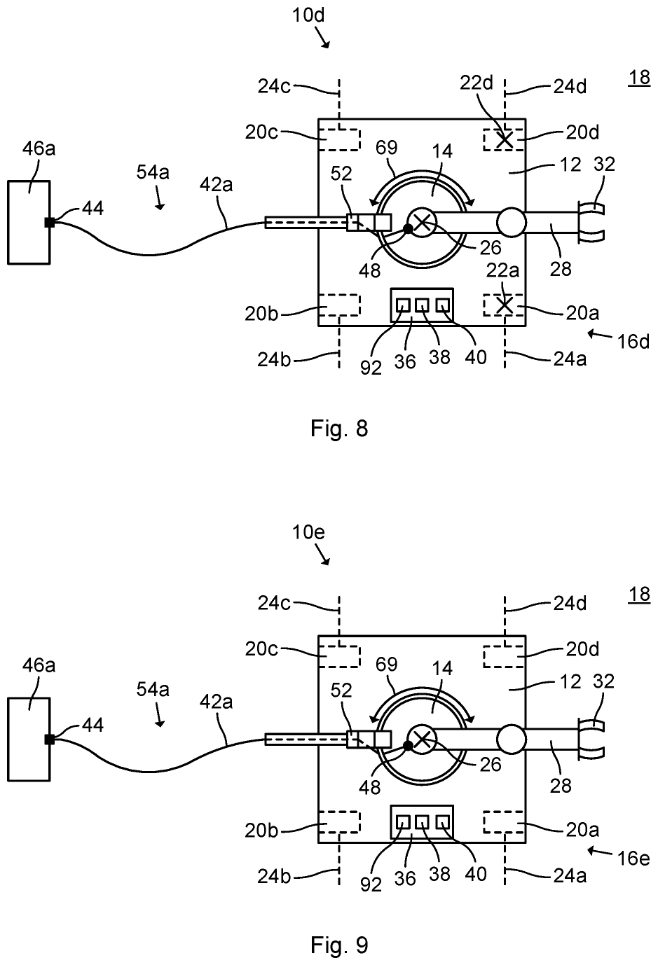

FIG. 9 schematically represents a top view of a further example of a mobile robot 10e. The mobile robot 10e comprises a traction arrangement 16e. The traction arrangement 16e differs from the traction arrangement 16a in that all wheels 20a-20d are fixed direction wheels. Similarly to the mobile robots 10c and 10d, the winding member 14 of the mobile robot 10e is rotatable relative to the body 12. The mobile robot 10e is not capable of performing an omnidirectional motion of the winding member 14. The traction arrangement 16e can only perform a one-dimensional translational motion 76 and the winding member 14 can perform a rotational motion 74 independently of the translational motion 76. Similarly to the mobile robot 10d, the second end 48 of the line 42a is directly connected to the manipulator base 30 in the mobile robot 10e.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A mobile robot comprising:
a body;
a winding member carried by the body;
a traction arrangement configured to move the body over a surface with a translational motion along a path; and
an elongated line wound around the winding member;
wherein the mobile robot is capable of performing a rotational motion of the winding member relative to the surface independently of the translational motion of the body.

2. The mobile robot according to claim 1, further comprising a consumer carried by the body and arranged to rotate in common with the winding member, wherein the line is connected to the consumer.

3. The mobile robot according to claim 1, wherein the mobile robot is configured to perform an omnidirectional motion of the winding member relative to the surface.

4. The mobile robot according to any claim 1, wherein the mobile robot is configured to perform the rotational motion, at least partially, by the traction arrangement.

5. The mobile robot according to claim 1, wherein the line includes a first end and a second end.

6. The mobile robot according to claim 5, wherein the first end is configured to be connected to a stationary device.

7. The mobile robot according to claim 1, wherein the rotational motion of the winding member includes a rotation about a rotation axis angled 45° to 135° to the surface.

8. The mobile robot according to claim 1, further comprising a guide for controlling a position of the line.

9. The mobile robot according to claim 8, wherein the guide is configured to control a winding position of the line relative to the winding member when the line is wound in on the winding member.

10. The mobile robot according to claim 8, wherein the guide is configured to control a lay down position of the line relative to the body when the line is wound out from the winding member.

11. A method of controlling a mobile robot, the method comprising:
providing a mobile robot having a body, a winding member carried by the body, a traction arrangement configured to move the body over a surface with a translational motion along a path, and an elongated line wound around the winding member, the mobile robot being capable of performing a rotational motion of the winding member relative to the surface independently of the translational motion of the body; and
controlling the mobile robot to perform the rotational motion of the winding member and the translational motion of the body to wind out the line from the winding member.

12. The method according to claim 11, wherein the rotational motion of the winding member is performed, at least partially, by the traction arrangement.

13. The method according to claim 11, further comprising laying the line along a non-straight path by the translational motion of the body and the rotational motion of the winding member, and storing position information associated with one or more positions of the path.

14. The method according to claim 13, further comprising controlling the mobile robot based on the position information to perform the translational motion of the body and the rotational motion of the winding member to wind in the line around the winding member.

15. A control system for controlling a mobile robot comprising:
a body;
a winding member carried by the body;
a traction arrangement configured to move the body over a surface with a translational motion along a path; and
an elongated line wound around the winding member, wherein the mobile robot is capable of performing a rotational motion of the winding member relative to the surface independently of the translational motion of the body; and
the control system se including at least one data processing device and at least one memory having at least one computer program stored thereon, the at least one computer program comprising including a program code which, when executed by the at least one data processing device, causes the at least one data processing device to control the mobile robot to perform a rotational motion of the winding member relative to the surface and the translational motion of the body to wind out the line from the winding member.

16. The mobile robot according to claim 2, wherein the mobile robot is configured to perform an omnidirectional motion of the winding member relative to the surface.

17. The mobile robot according to claim 2, wherein the mobile robot is configured to perform the rotational motion, at least partially, by the traction arrangement.

18. The mobile robot according to claim, wherein the line includes a first end and a second end.
